(19) United States
(12) Patent Application Publication
(10) Pub. No.: US 2016/0371107 A1
(43) Pub. Date: Dec. 22, 2016

(54) System and Method to Discover Virtual Machines from a Management Controller

(71) Applicant: Dell Products, LP, Round Rock, TX (US)

(72) Inventors: Chandrasekhar Puthillathe, Bangalore (IN); Rama R. Bisa, Kandukur (IN)

(21) Appl. No.: 14/743,454

(22) Filed: Jun. 18, 2015

(51) Int. Cl. G06F 9/455

(52) U.S. Cl. CPC G06F 9/45558; G06F 2009/45575; G06F 2009/45595

(57) ABSTRACT

An information handling system includes a processor to run a hypervisor and a management controller coupled to the hypervisor. The management controller includes a virtual Universal Serial Bus (USB) hub, and the hypervisor launches a virtual machine on the processor. In response to an indication from the hypervisor that the virtual machine has been launched, the management controller instantiates a USB virtual NIC coupled to the virtual USB hub, and provides an address of the USB virtual NIC to the hypervisor. The hypervisor provides the address to the virtual machine. The virtual machine provides information to the management controller via the USB virtual NIC.

### FIELD OF THE DISCLOSURE

This disclosure generally relates to information handling systems, and more particularly relates to a system and method to discover and manage virtual machines from a management controller of an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a flowchart illustrating a method to discover virtual machines from a management controller of an information handling system according to an embodiment of the present disclosure; and

FIG. 3 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

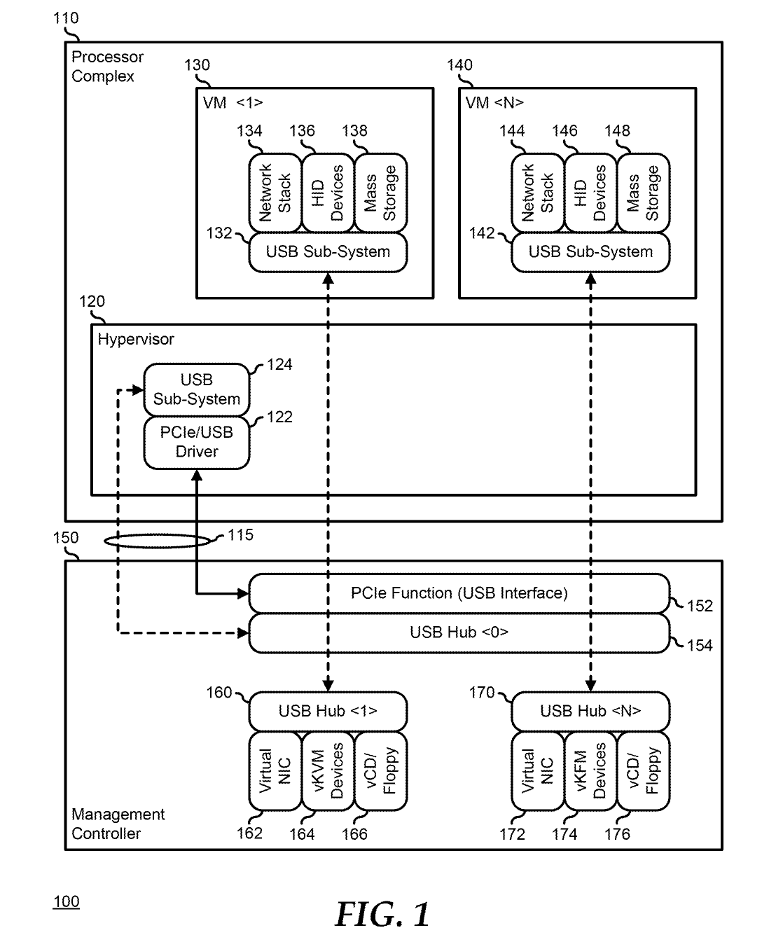

FIG. 1 illustrates an embodiment of an information handling system 100 that, for the purpose of this disclosure, can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 includes a processor complex 110 that is connected to a management controller 150 via a management interface 115. Processor complex 110 represents processing elements of information handling system 100 that perform the primary processing tasks of the information handling system. As such, processor complex 110 operates to launch a virtual machine hypervisor 120 on the resources of the processor complex. Hypervisor 120 in turn instantiates a virtual machine 130 and one or more additional virtual machines 140 on the resources of processor complex 110.

Management controller 150 represents separate processing elements of information handling system 100 that perform management tasks on the information handling system. In particular, management controller 150 permits remote out-of-band management of the hardware, software, firmware, and functionality of information handling system 100. In a particular embodiment, management controller 150 operates in accordance with the Intelligent Platform Management Interface (IPMI) specification, version 2.0. An example of management controller 150 includes a Baseboard Management Controller (BMC), an Integrated Dell Remote Access Controller (iDRAC), or another management controller, as needed or desired. Management interface 115 represents a data interface between processor complex 110 and management controller 150. In a particular embodiment, management interface 115 represents a Peripheral Component Interconnect-Express (PCIe) interface. In a particular embodiment, management controller 150 is connected to a management system that provides a user interface whereby an operator can interact with the management controller to direct the management tasks on information handling system 100.

Management controller 150 operates to provide visibility into virtual machines 130 and 140, thereby permitting remote out-of-band management of the virtual machines. In this regard, management controller 150 includes a Universal Serial Bus (USB) controller function 152 as one of the functions associated with management interface 115, and the management controller operates to launch a virtual USB hub 154 as the operational function associated with the USB controller function. As such, when information handling system 100 is booted up, the PCIe initialization operation performed by a system Basic Input/Output System (BIOS) or Universal Extensible Firmware Interface (UEFI) enumerates USB controller function 152 as a valid function on management interface 115, and recognizes that the USB controller function implements USB hub 154. In a particular embodiment, USB hub 154 represents a USB hub <0> that instantiates 127 USB ports, as allowed by the USB specification. In this way, even when management controller 150 has a hardware limitation as to the number of USB devices or ports that are supported, such as where an iDRAC has a hardware limitation of between seven (7) and ten (10) USB functions, depending on the version of the iDRAC device, here, such hardware limitations are eliminated by the inclusion of the virtual USB hub <0>, and one or more additional virtual USB hubs <N>, as described further below.

Hypervisor 120 includes a PCIe/USB driver 122 that translates USB functions and transactions for routing over management interface 115, and a USB sub-system 124 for handling USB functions and transactions for virtual machines 130 and 140. When hypervisor 120 is launched on processor complex 110, PCIe/USB driver 122 discovers USB controller function 152, and enables USB sub-system 124 to discover USB hub 154. In this way, hypervisor 120 establishes a virtual USB interface between the hypervisor and USB hub 154 over management interface 115, as indicated by the dashed line. In a particular embodiment, the emulation of the USB functions on management controller 150 that is provided by USB controller function 152 is provided to a server operating system running on processor complex 110, and not just to hypervisor 120.

When hypervisor 120 instantiates virtual machine 130, the virtual machine image includes a USB sub-system 132 that implements a USB network stack 134. In addition, the virtual machine image can include a USB human interface device (HID) interface 136, and a virtual Compact Disk/Floppy (vCD/Floppy) device 138, as needed or desired. USB subsystem 132 can implement one or more additional USB functions, as needed or desired. Also at this time, USB sub-system 124 provides an indication to USB hub 154 that a new virtual machine 130 has been instantiated. Upon receiving the indication, USB controller function 152 instantiates a virtual USB hub 160 that is connected to one of the ports of USB hub 154, and implements a USB virtual network interface card (NIC) 162. In addition, USB controller function 152 can implement a virtual keyboard/video/mouse (vKVM) device 164, and a vCD/Floppy device 166 that are connected to respective ports of USB hub 160, as needed or desired. USB hub 160 can also implement one or more additional USB functions, as needed or desired. At this point, USB hub 154 provides an indication to USB sub-system 124 that a new device is installed on the associated port.

Similarly, when hypervisor 120 instantiates virtual machine 140, the virtual machine image includes a USB sub-system 142 that implements a USB network stack 144, a USB HID interface 146, and a vCD/Floppy device 148. Also at this time, USB sub-system 124 provides an indication to USB hub 154 that another new virtual machine 140 has been instantiated. Upon receiving the indication, USB controller function 152 instantiates a virtual USB hub 170 that is connected to another port of USB hub 154, and implements a USB virtual NIC 172, a vKVM device 174, and a vCD/Floppy device 176 that are connected to respective ports of USB hub 170. At this point, USB hub 154 provides an indication to USB sub-system 124 that another new device is installed on the associated port.

Hypervisor 120 operates to isolate real I/O resources of information handling system 100 from virtual machines 130 and 140, to allocate virtual I/O resources to the virtual machines, and to map I/O transactions between the virtual I/O resources and the real I/O resources. As such, hypervisor 120 operates to expose USB hub 160 to USB sub-system 132, such that the USB sub-system discovers the USB hub, USB virtual NIC 162, vKVM device 164, and vCD/Floppy device 166. Virtual machine 130 operates to install associated drivers for USB hub 160, for USB virtual NIC 162, for vKVM device 164, and for vCD/Floppy device 166. In this way, a virtual USB interface between virtual machine 130 and management controller 150 is established, as indicated by the dashed line. Similarly, hypervisor 120 operates to expose USB hub 170 to USB sub-system 142, such that the USB sub-system discovers the USB hub, USB virtual NIC 172, vKVM device 174, and vCD/Floppy device 176. Virtual machine 140 operates to install associated drivers for USB hub 170, for USB virtual NIC 172, for vKVM device 174, and for vCD/Floppy device 176. In this way, a virtual USB interface between virtual machine 140 and management controller 150 is established, as indicated by the dashed line.

In a particular embodiment, when virtual machines 130 and 140 installs the associated drivers for USB virtual NICs 162 and 172, one or more of the virtual machines installs a Communications Device Class (CDC) driver or a Remote Network Driver Interface Specification (RNDIS) driver that issues a Media Access Control (MAC) address request to the associated virtual NIC via USB descriptors over the associated virtual interface. Here, when USB controller function 152 instantiates virtual USB hub 160 and implements USB virtual NIC 162, the USB controller function assigns a random private MAC address to USB virtual NIC 162. Similarly, when USB controller function 152 instantiates virtual USB hub 170 and implements USB virtual NIC 172, the USB controller function assigns a random private MAC address to USB virtual NIC 172. Then, when USB virtual NICs 162 and 172 receive the MAC address request from the associated driver, each USB virtual NIC will provide its associated random private MAC address back to the associated driver. At this point, the link layer, L2, is established between virtual machine 130 and management controller 150, and between virtual machine 140 and the management controller. In response to the establishment of the respective link layers, virtual machines 130 and 140 issue Link Layer Discovery Protocol (LLDP) frames to the linked USB virtual NICs 162 and 172. The LLDP frames include information related to the associated virtual machines 130 and 140. An example of information related to a virtual machine includes a chassis identifier with details related to the USB virtual NIC, a port identifier that can include the MAC address of the virtual port, a system name for the virtual machine, a management address that includes the virtual machine's USB virtual NIC Internet Protocol (IP) address. In a particular embodiment, one or more of virtual machines 130 and 140 may not support LLDP frames. Here, management controller 150 can implement a Dynamic Host Configuration Protocol (DHCP) server that is configured to allocate private IP addresses. Then, upon receiving a host name (DHCP option 12) or a domain name (DHCP option 15) from virtual machines 130 and 140, the DHCP server will assign an IP address to the associated virtual machine. Once management controller 150 receives the virtual machine information, the management controller operates to send the information to a management system that provides a user interface whereby an operator can interact with the management controller to direct the management tasks on virtual machines 130 and 140.

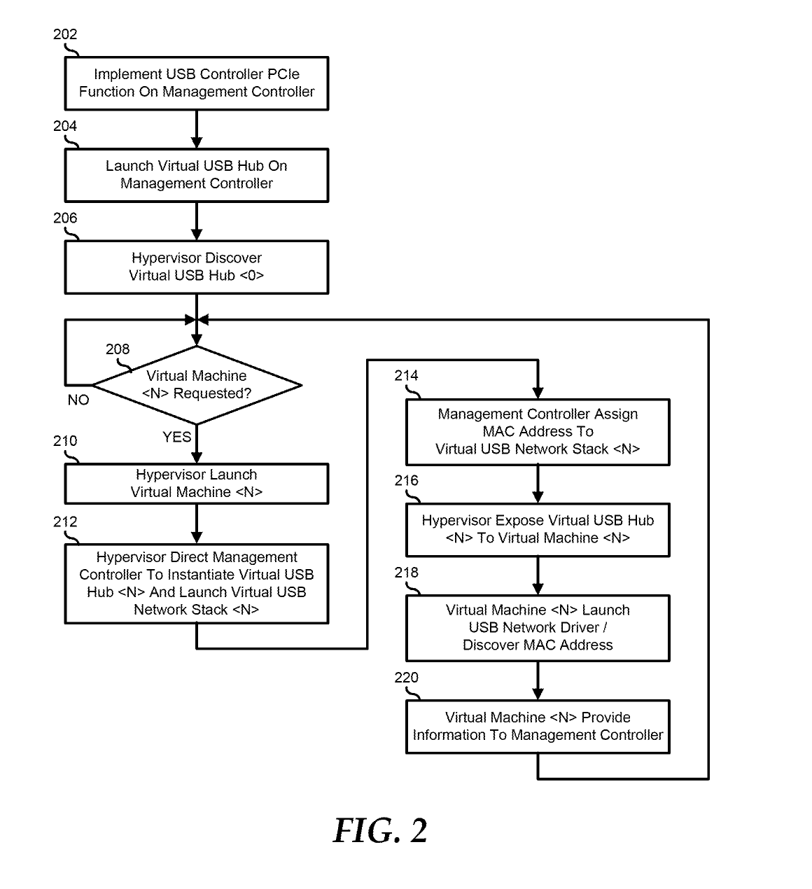

FIG. 2 illustrates a method to discover virtual machines from a management controller of an information handling system starting at block 202, where a management controller implements a USB controller PCIe function as one of the functions associated with management interface between the management controller and the information handling system. The management controller operates to launch a virtual USB hub as the operational function associated with the USB controller function in block 204. A hypervisor running on the information handling system includes a PCIe/USB driver that discovers the USB controller function 152 and the USB hub on the management controller in block 206. A decision is made as to whether or not a new virtual machine <N> is requested to be launched by the hypervisor in decision block 208. If not, the “NO” branch of decision block 208 is taken and the method loop at decision block 208 until a virtual machine is requested to be launched.

When a new virtual machine <N> is requested to be launched, the “YES” branch of decision block 208 is taken and the hypervisor launches the new virtual machine <N> in block 210. The new virtual machine <N> includes a USB sub-system. In block 212, the hypervisor directs the management controller to instantiates a virtual USB hub <N> that is connected to one of the ports of USB hub <0>, and to implement a virtual USB virtual NIC that is connected to a port of the USB hub <0>. The management controller assigns a random private MAC address to the virtual USB virtual NIC in block 214. In operating to isolate real I/O resources of the information handling system from the virtual machine <N>, the hypervisor exposes the USB hub <N> to the USB sub-system of the virtual machine in block 216. Virtual machine <N> installs an associated driver for the virtual USB virtual NIC and discovers the MAC address assigned to the virtual USB virtual NIC in block 218. The virtual machine <N> provides information related to the virtual machine <N> to the management controller in block 220 and the method returns to decision block 208 until an next new virtual machine is requested to be launched.

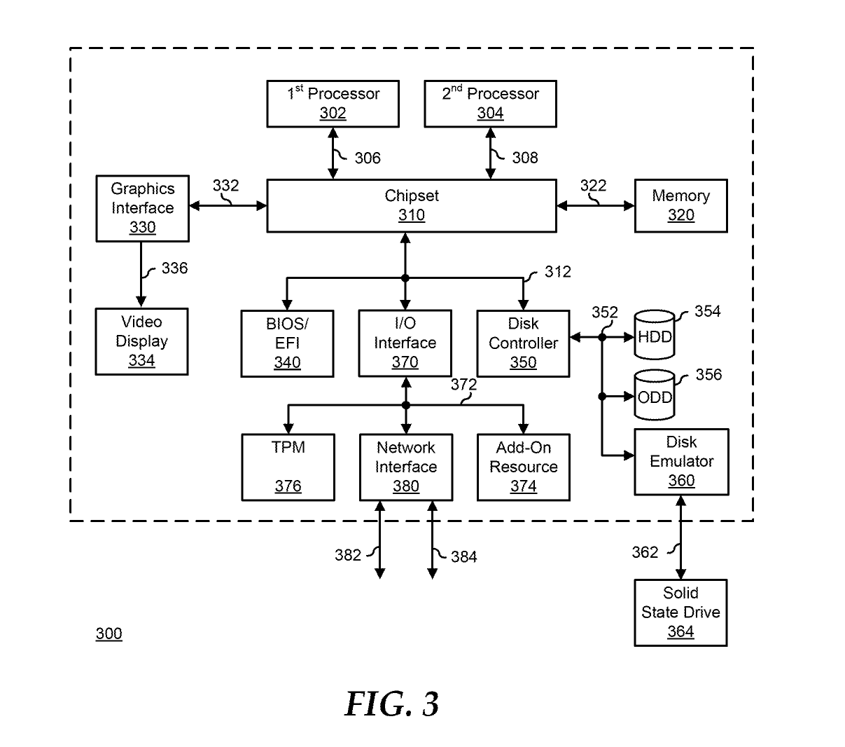

FIG. 3 illustrates a generalized embodiment of information handling system 300. For purpose of this disclosure information handling system 300 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described above, and operates to perform one or more of the methods described above. Information handling system 300 includes a processors 302 and 304, a chipset 310, a memory 320, a graphics interface 330, include a basic input and output system/extensible firmware interface (BIOS/EFI) module 340, a disk controller 350, a disk emulator 360, an input/output (I/O) interface 370, and a network interface 380. Processor 302 is connected to chipset 310 via processor interface 306, and processor 304 is connected to the chipset via processor interface 308. Memory 320 is connected to chipset 310 via a memory bus 322. Graphics interface 330 is connected to chipset 310 via a graphics interface 332, and provides a video display output 336 to a video display 334. In a particular embodiment, information handling system 300 includes separate memories that are dedicated to each of processors 302 and 304 via separate memory interfaces. An example of memory 320 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 340, disk controller 350, and I/O interface 370 are connected to chipset 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 340 includes BIOS/EFI code operable to detect resources within information handling system 300, to provide drivers for the resources, initialize the resources, and access the resources. BIOS/EFI module 340 includes code that operates to detect resources within information handling system 300, to provide drivers for the resources, to initialize the resources, and to access the resources.

Disk controller 350 includes a disk interface 352 that connects the disc controller to a hard disk drive (HDD) 354, to an optical disk drive (ODD) 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits a solid-state drive 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O interface 370 includes a peripheral interface 372 that connects the I/O interface to an add-on resource 374, to a TPM 376, and to network interface 380. Peripheral interface 372 can be the same type of interface as I/O channel 312, or can be a different type of interface. As such, I/O interface 370 extends the capacity of I/O channel 312 when peripheral interface 372 and the I/O channel are of the same type, and the I/O interface translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as chipset 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. An information handling system comprising:
a processor to run a hypervisor, wherein the hypervisor launches a first virtual machine on the processor; and
a management controller coupled to the hypervisor, wherein the management controller includes a first virtual Universal Serial Bus (USB) hub, the management controller configured to provide remote out-of-band management of the information handling system;
wherein:
in response to a first indication from the hypervisor that the first virtual machine has been launched, the management controller instantiates a first USB virtual network interface card (NIC) coupled to the first virtual USB hub, and provides a first address of the first USB virtual NIC to the hypervisor;
the hypervisor provides the first address to the first virtual machine; and
the first virtual machine provides first information to the management controller via the first USB virtual NIC.

2. The information handling system of claim 1, wherein:
the management controller further instantiates a virtual keyboard/video/mouse (vKVM) device coupled to the first virtual USB hub; and
the management controller provides a Human Interface Device (HID) input to the first virtual machine via the vKVM device.

3. The information handling system of claim 1, wherein:
the management controller further instantiates a storage device interface coupled to the first virtual USB hub; and
the virtual machine stores the information on the management controller via the storage device interface.

4. The information handling system of claim 1, wherein:
the hypervisor launches a second virtual machine on the processor;
in response to a second indication from the hypervisor that the second virtual machine has been launched, the management controller instantiates a second USB virtual NIC coupled to the first virtual USB hub, and provides a second address of the second USB virtual NIC to the hypervisor;
the hypervisor provides the second address to the second virtual machine; and
the second virtual machine provides second information to the management controller via the second USB virtual NIC.

5. The information handling system of claim 1, wherein the first information is provided to the management controller via a Link Layer Discovery Protocol (LLDP) frame to the first USB virtual NIC.

6. The information handling system of claim 1, wherein the first information comprises one of a virtual machine chassis identifier, a port of the virtual machine, a system name for the first virtual machine, and an Internet Protocol (IP) address of the virtual machine.

7. The information handling system of claim 1, wherein:
the hypervisor is coupled to the management controller via a management interface of the processor.

8. The information handling system of claim 7, wherein:
the management interface comprises a Peripheral Component Interconnect-Express (PCIe) link.

9. The information handling system of claim 8, wherein:
first virtual USB hub comprises a PCIe function on the PCIe link.

10. A method comprising:
providing a first virtual Universal Serial Bus (USB) hub on a management controller of an information handling system, wherein the management controller is configured to provide remote out-of-band management of the information handling system;
launching, by a hypervisor of the information handling system, a first virtual machine;
receiving a first indication from the hypervisor that the first virtual machine has been launched;
instantiating, on the management controller, a first USB virtual network interface card (NIC) coupled to the first virtual USB hub in response to receiving the first indication;
providing a first address of the first USB virtual NIC to the hypervisor;
providing the first address to the first virtual machine; and
providing, from the first virtual machine, first information to the management controller via the first USB virtual NIC.

11. The method of claim 10, further comprising:
instantiating, on the management controller, a virtual keyboard/video/mouse (vKVM) device coupled to the first virtual USB hub; and
providing a Human Interface Device (HID) input to the first virtual machine via the vKVM device.

12. The method of claim 10, further comprising:
instantiating, on the management controller, a storage device interface coupled to the first virtual USB hub; and
storing the information on the management controller via the storage device interface.

13. The method of claim 10, further comprising:
launching, by the hypervisor, a second virtual machine;
receiving a second indication from the hypervisor that the second virtual machine has been launched;
instantiating, on the management controller, a second USB virtual NIC coupled to the first virtual USB hub in response to receiving the second indication;
providing a second address of the second USB virtual NIC to the hypervisor;
providing the second address to the second virtual machine; and
providing, from the second virtual machine, second information to the management controller via the second USB virtual NIC.

14. The method of claim 10, wherein the first information is provided to the management controller via a Link Layer Discovery Protocol (LLDP) frame to the first USB virtual NIC.

15. The method of claim 10, wherein the first information comprises one of a virtual machine chassis identifier, a port of the virtual machine, a system name for the first virtual machine, and an Internet Protocol (IP) address of the virtual machine.

16. The method of claim 10, wherein the hypervisor is coupled to the management controller via a management interface of the processor complex.

17. A non-transitory computer-readable medium including code for performing a method, the method comprising:
providing a first virtual Universal Serial Bus (USB) hub on a management controller of an information handling system, wherein the management controller is configured to provide remote out-of-band management of the information handling system;
launching a first virtual machine;
receiving a first indication from a hypervisor that the first virtual machine has been launched;
instantiating, on the management controller, a first USB virtual network interface card (NIC) coupled to the first virtual USB hub in response to receiving the first indication;
providing a first address of the first USB virtual NIC to the hypervisor;
providing the first address to the first virtual machine; and
providing, from the first virtual machine, first information to the management controller via the first USB virtual NIC.

18. The computer-readable medium of claim 17, the method further comprising:
instantiating, on the management controller, a virtual keyboard/video/mouse (vKVM) device coupled to the first virtual USB hub; and
providing a Human Interface Device (HID) input to the first virtual machine via the vKVM device.

19. The computer-readable medium of claim 17, the method further comprising:
instantiating, on the management controller, a storage device interface coupled to the first virtual USB hub; and
storing the information on the management controller via the storage device interface.

20. The computer-readable medium of claim 17, the method further comprising:
launching, by the hypervisor, a second virtual machine;
receiving a second indication from the hypervisor that the second virtual machine has been launched;
instantiating, on the management controller, a second USB virtual NIC coupled to the first virtual USB hub in response to receiving the second indication;
providing a second address of the second USB virtual NIC to the hypervisor;
providing the second address to the second virtual machine; and
providing, from the second virtual machine, second information to the management controller via the second USB virtual NIC.
